(19) United States
(12) Patent Application Publication
(10) Pub. No.: US 2022/0332599 A1
(43) Pub. Date: Oct. 20, 2022

(54) SYSTEM AND METHODS FOR TREATMENT OF LEACHATE WATER

(71) Applicant: WATER NOW, INC., FORT WORTH, TX (US)

(72) Inventor: JEFFREY THOMAS OLSON, AZLE, TX (US)

(21) Appl. No.: 17/657,319

(22) Filed: Mar. 30, 2022

Related U.S. Application Data
(60) Provisional application No. 63/167,956, filed on Mar. 30, 2021.

(51) Int. Cl. C02F 1/20; C02F 1/00; C02F 1/68

(52) U.S. Cl. CPC C02F 1/20; C02F 1/006; C02F 1/686; C02F 2103/06

(57) ABSTRACT

An improved system and method for extracting volatile organic compounds (VOCs) such as ammonia from leachate water. Uses specialized pressurization of leachate water to extract VOCs which may then be recaptured in more highly concentrated water to reduce overall volume of contaminated water.

### CITATION TO PRIOR APPLICATIONS

The present application is a continuation of and claims priority to U.S. Provisional Application No. 63/167,956 entitled “Leachate Water Treatment,” filed Mar. 30, 2021.

### BACKGROUND AND SUMMARY

The conventional treatment of leachate waters, particularly waters containing high levels of volatile organic compounds (VOCs) including ammonia, often requires transport of such waters from standard water treatment facilities to hazardous waste facilities to accommodate the specialized needs of the treatment process. For example, in conventional air stripping methods, the target leachate water must be of a specific pH level and temperature to be properly treated. Additionally, these processes rely on membranes, or other materials through which the leachate water passes, which must be replaced once they become plugged.

It is an object of the present disclosure to describe improved systems and methods for treating leachate water. These methods do not rely on chemicals, filters, or membranes to remove ammonia. The presently disclosed methods facilitate stripping VOCs (such as ammonia) from leachate water and recapturing the resulting gas. Furthermore, these methods may be performed at a standard water treatment facility thereby allowing for more rapid recirculation of greater volumes of treated water into a municipal water supply.

### BRIEF DESCRIPTION OF THE FIGURES

FIG. 1 depicts a side view of a first leachate treatment tank in accordance with embodiments of the present disclosure.

FIG. 2 depicts a top view of a first leachate treatment tank in accordance with embodiments of the present disclosure.

FIG. 3 depicts a perspective view of a branch of first treatment trunk line in accordance with embodiments of the present disclosure.

FIG. 4 depicts a side view of a second leachate treatment tank in accordance with embodiments of the present disclosure.

FIG. 5 depicts a front view of a second leachate treatment tank in accordance with embodiments of the present disclosure.

FIG. 6 depicts a top view of a second leachate treatment tank in accordance with embodiments of the present disclosure.

FIG. 7 depicts a side cutaway view of a second leachate treatment tank in accordance with embodiments of the present disclosure.

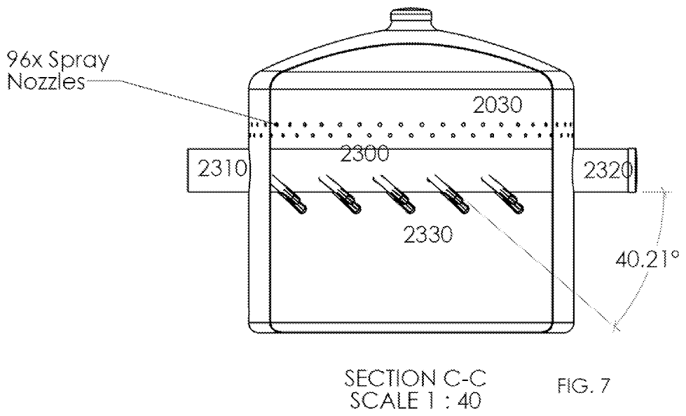

### DETAILED DESCRIPTION

This description, with references to the figures, presents non-limiting examples of embodiments of the present disclosure. Embodiments of this disclosure relate generally to treating and processing leachate water.

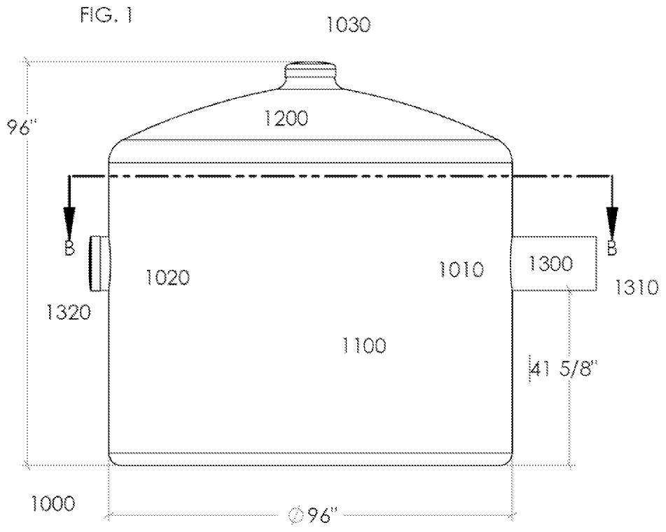

In some embodiments of this disclosure, a system for treating leachate water comprises a first leachate treatment tank. As depicted in FIG. 1, a first leachate treatment tank 1000 may have a first treatment trunk line 1300 arranged such that first treatment trunk line 1300 is partially disposed within an interior volume of first leachate treatment tank 1000. To facilitate this, first leachate treatment tank 1000 may have a first treatment trunk aperture 1010 positioned on an outer surface of said first leachate treatment tank 1000 to receive said first treatment trunk line 1300. In further embodiments, a second treatment trunk aperture 1020 positioned substantially opposite said first trunk treatment aperture 1010 relative the outer surface may be present to allow first treatment trunk line 1300 to traverse through first leachate treatment tank 1000. First leachate treatment tank 1000 may comprise a main body portion 1100. When first leachate treatment tank 1000 is filled with a liquid, first treatment trunk line 1300 is disposed within the interior volume such that it rests above the liquid level. A first leachate treatment tank 1000 may be substantially sealed at the top by a first sealing cap 1200 to prevent any unwanted escape of fluid or gas during the treatment process. In some embodiments, first leachate treatment tank 1000 has a top ventilation aperture 1030, which may be incorporated into first sealing cap 1200 where such a cap is present, configured to engage with an air circulation element. This air circulation element may be a conventional suction blower.

A first treatment trunk line 1300 may be substantially cylindrical in shape. A first treatment trunk line 1300 may also have a first treatment trunk end 1310 and a second treatment trunk end 1320. First treatment trunk line 1300 may be composed of any material suitable for use in water treatment processes including polyvinyl chloride (PVC). In some embodiments, a cap may be installed on second treatment trunk end 1320.

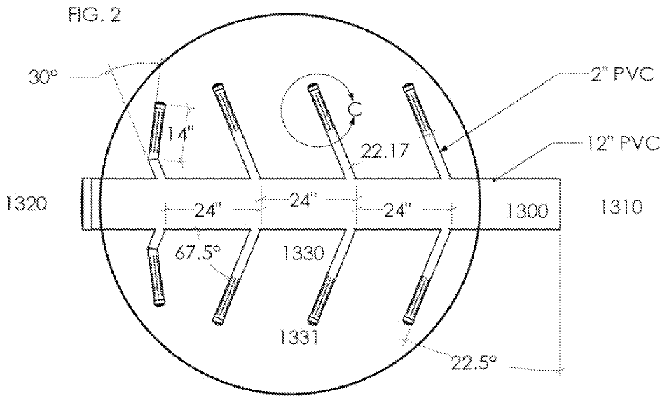

Seen in FIG. 2, first treatment trunk line 1300 may be coupled to one or more first trunk branch 1330 extending radially outward from said first treatment trunk line 1300. Each of said one or more first trunk branch 1330 may extend from a center line of said first treatment trunk line 1300. Each of said one or more first trunk branch 1330 may be positioned to point substantially perpendicular, on a horizontal plane, to a center line running the length of said first treatment trunk line 1300. In other embodiments, each of said one or more first trunk branch 1330 may be positioned to point at different angle on a horizontal plane relative to this center line. This angle may be between 10-90 degrees. Additionally, each of said one or more first trunk branch 1330 may be positioned to point at an angle on a vertical plane relative a center line running the length of said first treatment trunk 1300. This angle may be between 10-90 degrees. Optimally, the angles are such that each of said one or more first trunk branch 1330 can be at least partially submerged in a liquid contained within said first leachate treatment tank 1000 while said first treatment trunk line 1300 rests above the liquid line. Each of said one or more first trunk branch 1330 may be arranged in a row separated by a distance. In some embodiments a second row of trunk branches may be disposed elsewhere on the circumference of said first treatment trunk line 1300. In such embodiments, the angle of separation between the two, or potentially more, rows will still allow for every one of the one or more first trunk branch 1330 to become submerged in a liquid contained within said first leachate treatment tank 1000.

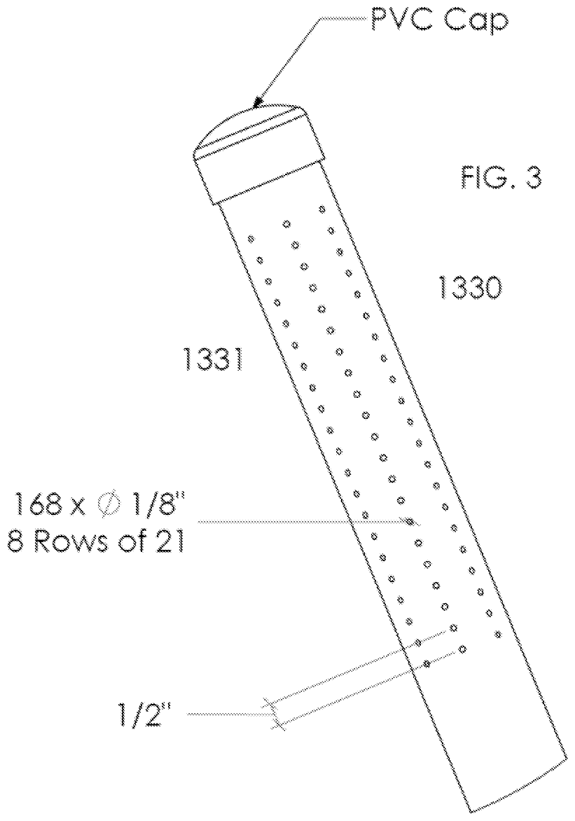

Looking at FIG. 3, the one or more first trunk branch 1330 may be substantially cylindrical in shape and have two open ends. A cap may be used to enclose each of the one or more first trunk branch 1330. The one or more first trunk branch 1330 may be coupled to said first treatment trunk line 1300 by any conventional means that would allow for air to flow from said first treatment trunk line 1300 through to said one or more first trunk branch 1330. Each of the one or more first trunk branch 1330 may have a plurality of apertures 1331. The plurality of apertures 1331 may be disposed primarily on only a portion of each of said one or more first trunk branch 1330. In some embodiments the plurality of apertures 1331 may be eight rows position around the outer surface, and running the length, of the portion of each respective branch, each row having twenty-one apertures. Each of the one or more first trunk branch 1330 may be composed of any material suitable for use in water treatment processes including PVC.

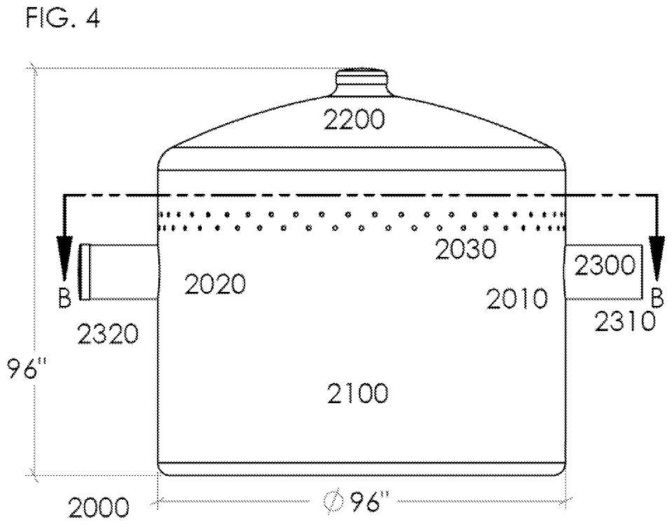

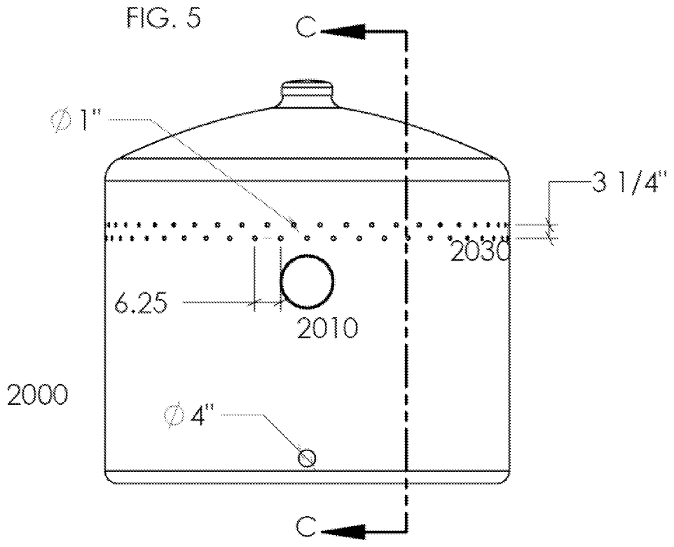

In further embodiments, a system for treating leachate water may further comprise a second leachate treatment tank 2000 coupled to first leachate treatment tank 1000. The general dimensions and configuration of first leachate treatment tank 1000 and second leachate treatment tank 2000 may be similar. Second leachate treatment tank 2000, as shown in FIGS. 4-5 may have a main body portion 2100, a sealing cap 2200, and be coupled to a second treatment trunk line 2300. Second leachate treatment tank 2000 may have a first treatment trunk aperture 2010 and a second treatment trunk aperture 2020 configured similar to corresponding structures of the first leachate treatment tank 1000. Additionally, second leachate treatment tank 2000 may have at least one injection element 2030 disposed radially around said second leachate treatment tank 2000. The at least one injection element may be a spray nozzle or other structure suitable to allow controlled liquid injection into second leachate treatment tank 2000.

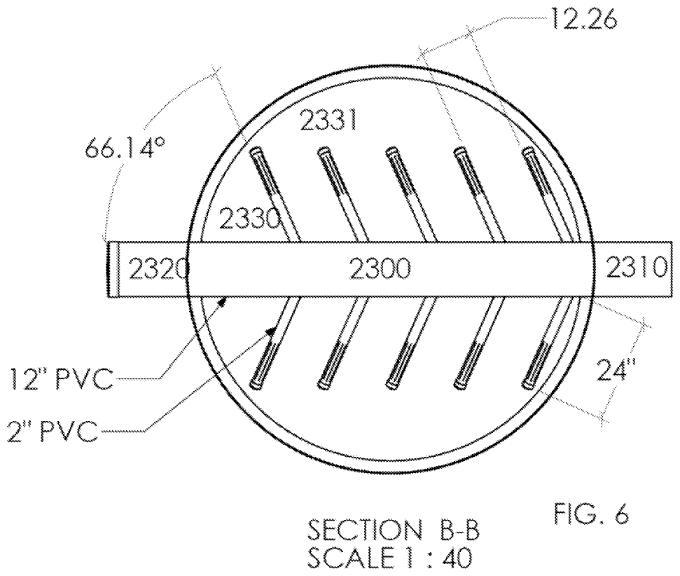

Second treatment trunk line 2300 may have one or more second trunk branch 2330 that are configured similarly to those of first treatment trunk line 1300. In some embodiments, the number, angle, and arrangement of trunk branches may differ as between the first and second treatment trunk lines, as seen when comparing FIGS. 2 and 6. Second treatment trunk line 2300 may also have a first end 2310 and a second end 2320 that may be configured similarly to corresponding structures of first treatment trunk line 1300.

To utilize a system in accordance with embodiments of this disclosure, leachate water would be pumped into a first leachate treatment tank 1000. An exemplary tank may be 8′ in diameter with an interior volume greater than the amount of leachate pumped in. In some embodiments, the target volume of leachate is around 1660 gallons. Once the leachate is pumped into first leachate treatment tank 1000, 60,000 cubic feet per minute (cfm) with 12″ static pressure high-volume, low-pressure air is pumped in through the first treatment trunk line 1300. An exemplary first treatment trunk line 1300 may be 12″ in diameter. The air will then flow through the one or more first trunk branch 1330 and through the respective apertures. Additionally, at the bottom of the tank is a high-volume pump that pulls water from the bottom and circulates it to the top to ensure all leachate water comes into contact with the high-volume air. In this exemplary embodiment, the branches protrude down into the leachate water at a 22.5 degree angle off set off the bottom center line of the trunk at 45 degrees to approximately 12″ of depth. Each branch has eight rows comprising twenty-one apertures having ⅛″ diameter and placed ½″ apart.

By pumping the high-volume air into the leachate water in this manner, the VOCs (such as ammonia) contained within the leachate water change phase back into gas and are carried out of the water into the air. In the top of the tank is sealed ventilation aperture 1030 which is coupled to another 60,000 cfm at 12″ static pressure high volume blower which suctions the reclaimed gaseous VOCs. This suction blower is also coupled to first end 2310 of second treatment trunk line 2300 and causes these gases to flow into second leachate treatment tank 2000 via second treatment trunk line 2300.

Prior to beginning this process, second leachate treatment tank 2000 is filled with 1660 gallons of clean water. As the suction blower coupled between the first and second treatment tanks begins to force vapors from first leachate treatment tank 1000 through second treatment trunk line 2300, the vapors begin to flow through the branches of second treatment trunk line 2300 into the clean water. Second treatment trunk line 2300 may also be an exemplary 12″ diameter pipe with branches that extend, and cause their respective apertures to rest, just below the surface of the water. While the vapors are being pumped in, an additional high-volume pump is pulling water from the bottom of the second tank. This water is run through an injection pump where a bonding solution is injected into the water stream which is then dispersed back into the tank through the at least one injection element 2030. The bonding solution may be any conventional chemical or solution configured to facilitate bonding of gases or vapors with water such as an ammonia buffer solution. The steps of the process in the second tank effectively create a “blanket” of water that is designed to capture the gases and vapors extracted from the first tank and to minimize the risk of gas escaping through vapor transfer. This allows for higher concentrations of VOCs in the second tank's water while preventing gas from escaping the second tank.

Through this exemplary process, VOCs (such as ammonia) can be removed from leachate water and forced into another water source at much higher concentrations thereby resulting in lower volumes of contaminated water. The process may take up to forty-eight hours to complete. Once complete, the leachate water should be clean enough to be transferred to a municipal water treatment facility giving the local municipality more water for future use. During operations, the size of the suction blowers and depth or number of branches may vary depending on the volume of leachate processed per day. When considering these variations, one exemplary benchmark is to use a blower capable of 3 cfm per gallon of leachate, 1″ of static pressure per inch of depth the branches protrude into the leachate. On the suction side, 5 cfm per 1 cfm of leachate blower cfm.

Although particular detailed embodiments of the system and method have been described herein, it should be understood that the disclosure is not restricted to the details of these embodiments. Many changes in design, composition, and configuration are possible without departing from the spirit and scope of the instant disclosure.

1. A system for treatment of leachate water comprising:
a first treatment tank;
a first treatment trunk line comprising at least one first trunk branch that extends outward from said first treatment trunk line, wherein said first treatment tank comprises a first trunk line aperture configured to receive said first treatment trunk line; wherein said first treatment trunk line is configured to be at least partially disposed within said first treatment tank;
a first air pump coupled to said first treatment trunk line, wherein said first air pump is configured to cause air to be pump through said at least one first trunk branch and into a contaminated fluid; and
a first suction pump coupled to said first treatment tank, wherein said first suction pump is configured to extract a contaminant vapor extracted from said contaminated fluid.

2. The system of claim 1 wherein said at least one first trunk branch comprises a plurality of apertures.

3. The system of claim 1 further comprising a second treatment tank operationally coupled to said first treatment tank and a second treatment trunk line at least partially disposed within said second treatment tank.

4. The system of claim 3 wherein said first suction pump is further configured to cause said contaminant vapor to flow through said second treatment trunk line into said second treatment tank.

5. The system of claim 4 further comprising an injection pump operationally coupled to said second treatment tank, wherein said injection pump is configured to inject a bonding solution configured to facilitate bonding of vapors and water into an uninjected volume of water from said second treatment tank and to return an injected volume of water back into said second treatment tank.

6. A method for treating leachate water comprising:
causing a volume of contaminated water to flow into a first treatment tank;
causing air to flow into said contaminated water through at least one first trunk branch of a first treatment trunk line, wherein said at least one first trunk branch comprises a plurality of apertures disposed in said contaminated water;
extracting a contaminant vapor through a first suction pump coupled to said first treatment tank; and
causing said contaminant vapor to flow into a receiving volume of water contained in a second treatment tank via a second treatment trunk line.

7. The method of claim 6 further comprising:
injecting a bonding solution configured to facilitate bonding of vapors and water into an uninjected volume of water from said second treatment tank,
causing an injected volume of water containing said bonding solution to enter said second treatment tank; and
causing said contaminant vapor to make contact with said injected volume of water.
